(19) United States
(12) Patent Application Publication
(10) Pub. No.: US 2023/0230123 A1
(43) Pub. Date: Jul. 20, 2023

(54) SYSTEM AND METHOD SELF-SERVICE FOR PUBLIC RADIO SPONSORSHIP ORDERING AND COPYWRITING OF ADVERTISEMENT

(71) Applicants: Stacy Bertinelli, Scottsdale, AZ (US); Paul Steinhafel, Glendale, WI (US); Jim Taszarek, Paradise Valley, AZ (US)

(72) Inventors: Stacy Bertinelli, Scottsdale, AZ (US); Paul Steinhafel, Glendale, WI (US); Jim Taszarek, Paradise Valley, AZ (US)

(21) Appl. No.: 18/097,977

(22) Filed: Jan. 17, 2023

Related U.S. Application Data
(60) Provisional application No. 63/266,825, filed on Jan. 14, 2022.

(51) Int. Cl. G06Q 30/0241

(52) U.S. Cl. CPC G06Q 30/0249

(57) ABSTRACT

A system for self-service public radio sponsorship ordering and copywriting of advertisement is disclosed. The system comprises a server and a network interface. The server includes a threshold analyzer configured to receive a budget request from a user and determine if the budget request is within a pre-determined budget range, a payment system for receiving payment information from the user, a scheduler for scheduling an airtime for an advertisement from the user, and an advertisement copywriting generator for generating a preapproved draft message for the user, wherein the draft message is for the advertisement from the user The network interface in signal communication with the server, wherein the network interface is configured to communicate with a remote computing device over a telecommunication network.

### CROSS REFERENCE TO RELATED APPLICATIONS

This application claims the benefit of U.S. Provisional Application No. 63/266,825, file Jan. 14, 2022, entitled “SYSTEM AND METHOD SELF-SERVICE FOR PUBLIC RADIO SPONSORSHIP ORDERING AND COPYWRITING OF ADVERTISEMENT,” the entire contents of which are hereby incorporated herein by reference.

### BACKGROUND

### 1. Field

The present disclosure relates in general to advertisement ordering and copywriting, and more specifically, to advertisement ordering and copywriting of advertisement for public radio.

### 2. Related Art

At present, over 200 million people listen to the radio every month, translating to a very large percentage of the population in the United States. Radio remains popular with listeners for many reasons, including the fact that it is free and easily accessible through car radios, stereos, laptops, phones, computers, and smart speakers, and there is a station and genre for everyone. For marketers, radio provides the ability to reach a large audience with their marketing message. However, in the United States, there are two distinct types of radio stations with much different operational methods: public radio and commercial radio.

Commercial radio stations make money by selling advertising. Having a large listening audience leads to more advertisers. The more advertisers a commercial radio station has, the more it can charge for its advertising thus generating a profit. On the other hand, public radio stations represent public or non-commercial radio. Unlike commercial radio stations, public radio stations do not air commercials, rather, they air sponsorship messages from businesses or organizations that support the public radio station. The United States Federal Communications Commission (FCC) strictly specifies that non-profit stations cannot broadcast commercials for for-profit businesses. Instead, these businesses can sponsor public radio following messaging guidelines created and policed by the FCC. Generally, these sponsors provide “underwriting” or “sponsorship” rather than advertising.

In general, public radio listeners view sponsors differently than advertisers on commercial radio because a typical commercial radio listener may change the channel when they feel a commercial is intruding on their entertainment, while public radio listeners do not. As such, public radio sponsors may leverage the positive association and shared values attributed to them as public radio station supporters.

The FCC messaging guidelines for sponsor messaging on public radio utilize a fundamental distinction between audiences where the differences in public radio versus commercial radio can be summarized as follows: commercial radio ads are centered around a call to action meant to influence the listener, while public station messages resonate with the listeners who act on the information provided; commercial ads are designed to drive sales compared to public radio sponsorship messages that inform and improve lead generation; commercial radio ads are often viewed as intrusive, while sponsorship messages are perceived as more philanthropic and beneficial for supporting causes the listeners identify with; and commercial radio airs up to 15 minutes of advertising per hour, while public radio stations typically only run 2-5 minutes of sponsor messages per hour, resulting in more listener enjoyment of programming and less channel hopping. Thus, in general, public radio listeners trust sponsorship messages.

Based on these limitations, a problem arises with respect to funding the operating budget of many public radio stations. The problem is that corporate sponsorship typically represents about 50% of the operating budget of a public radio station, while the rest of the budget comes from pledge drives. Within the corporate sponsorship, less than 10% of the operating budget comes from the radio station’s smallest accounts on air. These accounts are from small sponsor that might be on once or twice a year for maybe one- or two-week campaigns where they might spend between, for example, $500 to $1,000. These sponsors are generally trying to raise awareness for community events that are limited time events.

The problem is that while these small sponsors may account individually for less than 10% of the operating budget, they may still account for 35 to 40% of the total number of sponsors on the air for the radio station. Because these sponsors are not sophisticated media buyers, they typical cause higher overhead costs for the radio station to process than normal and can take as much overhead costs and efforts as much higher spending sponsors that are more sophisticated in purchasing media airtime. As an example, due to their limited marketing infrastructure, sponsors with small budgets (such as for example Community Accounts) tend to have time-intensive sales processes compared to their investment in a sponsorship campaign purchased from the radio station. These clients require more education on effective radio scheduling, and frequently do not have the marketing budget to afford a minimum effective schedule (as example, capturing 33% of a station’s weekly cumulative audience). When they can afford a minimum effective schedule, they often demand multiple copy revisions because they do not understand FCC guidelines for public radio copy. Moreover, even when schedule and copy concerns are resolved, approximately 50% of Community Accounts do not renew year over year and many do not pay their invoices. Therefore, there is a need for a system and method that address these issues.

### SUMMARY

Disclosed is a system for self-service public radio sponsorship ordering and copywriting of advertisement. The system comprises a server and a network interface. The server includes a threshold analyzer configured to receive a budget request from a user and determine if the budget request is within a pre-determined budget range, a payment system for receiving payment information from the user, a scheduler for scheduling an airtime for an advertisement from the user, and an advertisement copywriting generator for generating a preapproved draft message for the user, wherein the draft message is for the advertisement from the user. The network interface in signal communication with the server, wherein the network interface is configured to communicate with a remote computing device over a telecommunication network.

Also disclosed is a system for self-service public radio sponsorship ordering and copywriting of advertisement, the system comprising a communications interface, a computer-readable medium having executable instructions, and a processor, in signal communication with the communications interface and the computer-readable medium, the processor configured to perform operations based on the executable instructions. The operations include receive from a user, utilizing a remote computing device, a sponsorship request via a telecommunication network, determine if the user has a budget that is within a pre-determined budget range, determine an airtime to air a message from the user, determine a goal of a sponsorship of the user, process a payment from the user, and generate a message to transmit over the air with a station traffic system.

Further disclosed is a method for self-service public radio sponsorship ordering and copywriting of advertisement. The method comprises receiving from the user, utilizing the remote computing device, a sponsorship request at the server remote from the remote computing device via the telecommunication network, requesting the budget from the user with the server, and receiving the budget information from the user at the server. The method also comprises determining, with the threshold analyzer, if the received budget information is below a first threshold budget or above a second threshold budget, rejecting the sponsorship request if the received budget information is below the first threshold budget, and transmitting the sponsorship request to a different department if the received budget information is above the second threshold budget.

The method further comprises requesting that the user create a user account if the received budget information is above the first threshold budget and below the second threshold budget, transmitting potential schedules to air a message from the user from a scheduler, receiving a chosen schedule from the user, transmitting potential airtimes to air the message, and receiving a chosen airtime from the user.

Moreover the method further comprises querying user for the goal of the sponsorship, receiving the goal of the sponsorship from the user, transmitting a creative/copy generation form to the user from an advertisement copywriting generator, receiving from the user a completed creative/copy generation form, querying user for payment information, receiving payment information from the user, generating a preapproved message from the completed creative/copy generation form with the advertisement copywriting generator, transmitting the preapproved message to the user for approval, charging the payment information from the user if the user approves the preapproved message, and transmitting the approved message to a station traffic system to air the approved message.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a system block diagram of an example of an implementation of a system for self-service public radio sponsorship ordering and copywriting of advertisement in accordance with the present disclosure.

FIG. 2 is a system diagram of an example of an implementation of the server 102 is shown in in FIG. 1 in accordance with the present disclosure.

FIG. 3 is a flowchart of an example of an implementation of method of operation for system the self-service public radio sponsorship ordering and copywriting of advertisement shown in FIG. 1 in accordance with the present disclosure.

FIGS. 4 through 23 are example screen shots of communication between the system and a user on the user’s remote computing device.

### DETAILED DESCRIPTION

A system for self-service public radio sponsorship ordering and copywriting of advertisement is disclosed. The system comprises a server and a network interface. The server includes a threshold analyzer configured to receive a budget request from a user and determine if the budget request is within a pre-determined budget range, a payment system for receiving payment information from the user, a scheduler for scheduling an airtime for an advertisement from the user, and an advertisement copywriting generator for generating a preapproved draft message for the user, wherein the draft message is for the advertisement from the user. The network interface in signal communication with the server, wherein the network interface is configured to communicate with a remote computing device over a telecommunication network.

Also disclosed is a system for self-service public radio sponsorship ordering and copywriting of advertisement, the system comprising a communications interface, a computer-readable medium having executable instructions, and a processor, in signal communication with the communications interface and the computer-readable medium, the processor configured to perform operations based on the executable instructions. The operations include receive from a user, utilizing a remote computing device, a sponsorship request via a telecommunication network, determine if the user has a budget that is within a pre-determined budget range, determine an airtime to air a message from the user, determine a goal of a sponsorship of the user, process a payment from the user, and generate a message to transmit over the air with a station traffic system.

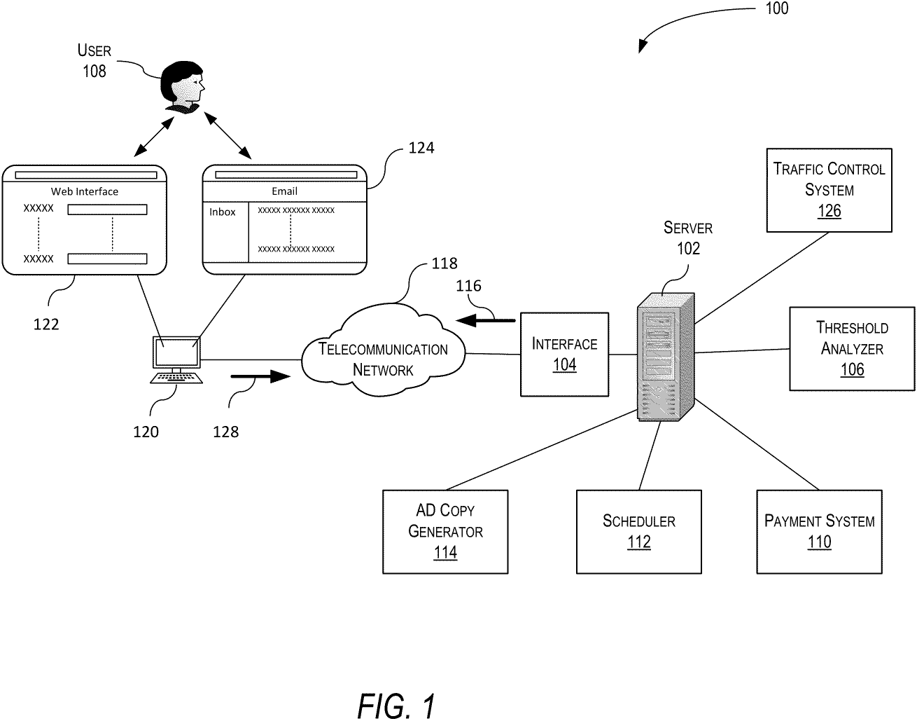

In FIG. 1, a system block diagram of an example of an implementation of a system 100 for self-service public radio sponsorship ordering and copywriting of advertisement is shown in accordance with the present disclosure. The system 100 comprises computing device such as, for example, a server 102 and a network interface 104. The server 102 includes a threshold analyzer 106 configured to receive a budget request from a user 108 and determine if the budget request is within required limits, a payment system 110 for receiving payment information from the user 108, a scheduler 112 for scheduling an airtime for an advertisement from the user 108, and an advertisement copywriting (AD copy) generator 114 for generating a preapproved draft message 116 for the user 108, wherein the draft message 116 is for the advertisement from the user 108. The network interface 104 is in signal communication with the server 102 and a telecommunication network 118, wherein the network interface 104 is configured to communicate with a remote computing device 120 via the telecommunication network 104.

In this example, the remote computing device 120 may be computer (such as a desktop personal computer), portable computer (such as a laptop), mobile device (such as a tablet or smartphone), or other similar device. The telecommunication network 118 may be the Internet or other wired or wireless telecommunication network. The user 108 may communicate with server 102 via web interface 122 or email or other messaging interface 124 on the remote computing device 120. In this example, the server 102 may also be in signal communication with a traffic control system 126 that is a system that controls the airtime traffic of the radio station, such as a public radio station. The traffic control system 126 may also be a computing device such as, for example, another server or non-server computer system.

In this example, the threshold analyzer 106, payment system 110, scheduler 112, and AD copy generator 114 may be implemented as systems either within the server 102 (such as hardware/software components or modules) or as separate systems that are in signal communication with the server 102. These systems may be implemented in hardware, software, or a combination of both as is appreciated by those of ordinary skill in the art. Moreover, the AD copy generator 114 maybe a processor-based system (e.g., a computer system and/or server) that utilizes artificial intelligence (AI) to generate the preapproved draft message, where the AI includes a system that includes a processor, memory, and software that is configured to automate the generation of the preapproved draft message 116 based on information 128 provided via the computing device 120 from the user 108.

In general, the system 100 is a self-serve, web-based portal 122 where clients (i.e., client like user 108) identify their annual budget and their request are sent to the appropriate channel. If their budget is below a minimum threshold, the request is denied and they are invited to do something else, for example, to opt-in for an e-newsletter. If the requests are above a maximum threshold, they are referred to another department where they may be referred to a live account manager for personal service. If their budgets are between the two parameters, their requests advance into the system 100 where the requester (i.e., the client such as user 108) will: provide basic contact information; self-identify their budget, allowing them to be assigned to the correct department; create an account; choose among, for example, two or three standard schedules; select the weeks they’d like to air using a date picker in the scheduler; choose the goal for their campaign based on their organizational structure (small business, nonprofit, event); complete the creative / copy generator form; input their payment information (such as, for example, charge card information) on the payment page; review and acknowledge the Terms and Conditions; receive and review the preapproved draft message via their account portal; approve the draft message or request a revision; approve or reject the final revised message in their account portal; and if approved, the charge card is charged and the order and copy are advanced to the station’s traffic system that is in signal communication with the server 102. This system 100 may be designed to be utilized by small businesses, nonprofits and events planners to schedule one-week campaigns.

In this example, the user 108 is an individual but may be an automated device of software component of module capable of interfacing with the server 102 to search the one of more telecommunication networks 118 such as, for example, the Internet. As an example, the computing device 120 may also include a software application (i.e., program) for browsing (i.e., searching and viewing information) the Internet, where the software application is stored on a memory unit within the computing device 120. This software application of the web-based portal 122 may be a web-browser (commonly referred to as a browser) for accessing information on the World Wide Web that is part of the Internet. At present, examples of known browsers include, for example, Google Chrome(R) produced by Google LLC. of Mountain View, California, Mozilla Firefox(R) produced by Mozilla Foundation of Mountain View, California, Safari(R) produced by Apple, Inc. of Cupertino, California, and Internet Explorer(R) and Edge(R) produced by Microsoft Corporation of Redmond, Washington. The executable instructions of the browser are loaded in computer-readable media on the computing device 120 for execution by the one or more processors of the computing device 120. In general, the computer-readable media is a computer or machine-readable medium that is a medium capable of storing data in a format readable by a computer and/or mechanical device rather than human readable.

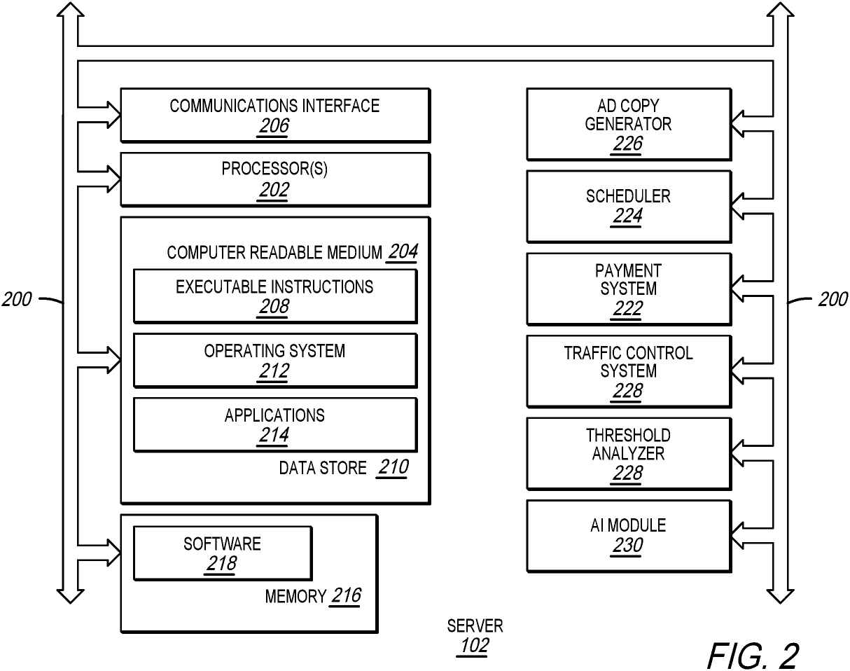

FIG. 2 is a system diagram of an example of an implementation of the server 102 is shown in in FIG. 1 in accordance with the present disclosure. In this example, the components of the server 102 are in signal communication and operatively connected, for example, via a bus 200, which can include one or more of a system bus, a data bus, an address bus, a PCI bus, a Mini-PCI bus, and any variety of local, peripheral, and/or independent buses. In this example, the sever 102 may include one or more processing unit(s)/processor(s) 202, computer-readable media 204, and/or communication interface(s) 206. The components of the server 102 are in signal communication and operatively connected, for example, via the bus 200.

As utilized herein, the processor(s) 202 may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized in this disclosure, a computer-readable media, such as computer-readable media 204 may store instructions executable by the processor(s) 202. The computer-readable media 204 may also store executable instructions 208 that may be executable by the processor(s) 202 and/or external processing units (not shown) such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in processor(s) 202, while in some examples one or more of a CPU, GPU, and/or accelerator may be external to a processor(s) 202 and/or server 102.

Computer-readable media 204 may include computer storage media (i.e., data store 210) and/or communication media. The data store 210 may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, data store 210 includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In this example, the computer-readable medium 204 (also known as computer-readable media, machine-readable medium, machine-readable media, etc.) may also include software such as an operating system 212 to control and operate the server 102 and application programs 214 to configure and enable the server 102 to do numerous operations and/or functions.

In some examples, the data store 210 includes data storage such as a database, data warehouse, or other type of structured or unstructured data storage. In some examples, the data store 210 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

The server 102 may also include a memory 216 that is configured to store software 218. In this example, the threshold analyzer 220, payment system 222, scheduler 224, AD copy generator 226, and traffic control system 228 may optionally be implemented as components, devices, or modules that are hardware, software, or both within the server 102. The server 102 may also include an AI module 230 that is a device, component, or module that is in signal communication with the other devices within the server 102 via the bus 200. The AI module 230 may be implemented in software 218 that is run by the processor(s) 202 or as a separate device that includes its own processor, memory, computer-readable medium, and other components. The AI module 230 may also be integrated into the AD Copy Generator 226, where the AD Copy Generator 226 may be an integrated or stand-alone computing system having its own processor(s), memory, software, computer-readable medium, and applications. The AI module 230 may also be implemented as a standalone system that is remote from but in signal communication with the server 102.

In this example, the memory 216 may be implemented as memory module such as, for example, a RAM, DRAM, PCM, ROM, EPROM, EEPROM, CD-ROM, DVD, Universal Serial Bus (USB), or other similar type of devices. The memory 216 is in signal communication with the bus 200 such that the software 218 is useable by other devices of the server 102 such as, for example, the processor(s) 202, computer-readable medium 204, the communications interface 206, threshold analyzer 220, payment system 222, scheduler 224, AD copy generator 226, traffic control system 228, and AI module 230.

In this example, the communication interface 206 may represent, for example, network interface controllers (“NICs”) or other types of transceiver devices to send and receive communications over a network.

It is appreciated by those skilled in the art that the circuits, components, modules, and/or devices of, or associated with, the system 100 are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying digital formats without passing through a direct electromagnetic connection.

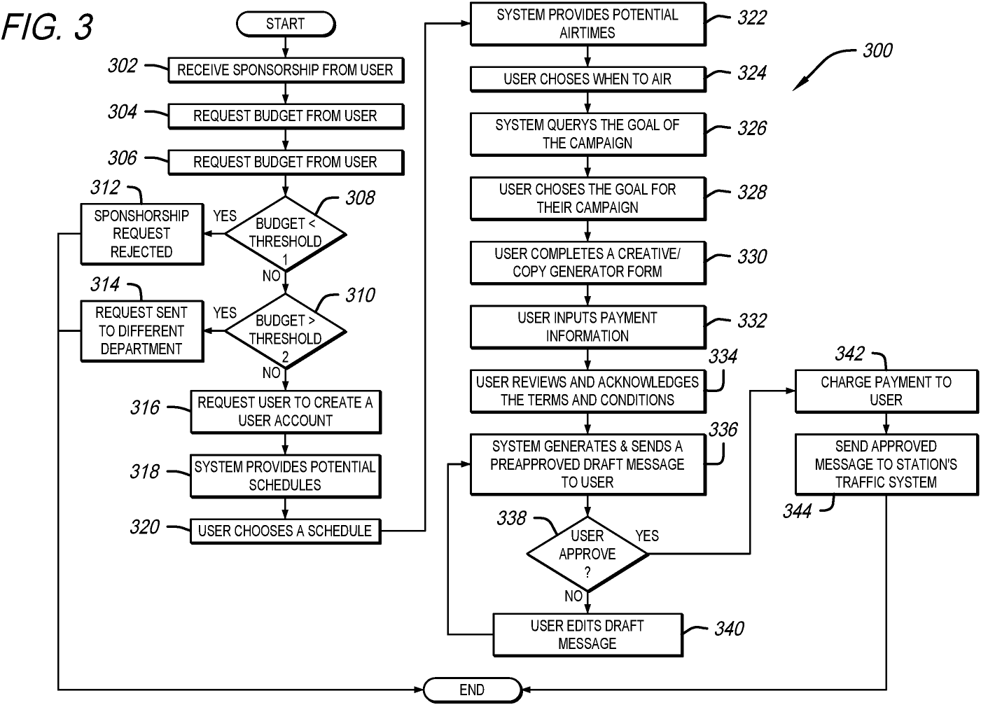

Turning to FIG. 3, a flowchart of an example of an implementation of method 300 of operation of the system 100 for the self-service public radio sponsorship ordering and copywriting of advertisement is shown in accordance with the present disclosure. The method 300 is performed by or in combination with the server 102. The method 300 starts and comprises the steps of receiving 302, from the user 108 utilizing the remote computing device 120, a sponsorship request at the server 102 that is remote from the remote computing device 120 via the telecommunication network 118, requesting 304 a budget from the user 108 with the server 102, and receiving 306 the budget information from the user 108 at the server 102.

The method 300 then utilizes the threshold analyzer 106 to determine if the received budget information is within a pre-determined budget range. If the received budget information is within the pre-determined budget range, the method 300 continues. If not, the method 300 ends. In this example, the pre-determined budget range is a monetary range that has been pre-determined and set by the operator of the system 100.

Specifically, the threshold analyzer 106 determines 308 if the received budget information is below a first threshold budget and also determines 310 if the received budget information is above a second threshold budget. The threshold analyzer 106 then rejects 312 the sponsorship request if the received budget information is below the first threshold budget (i.e., below the pre-determined budget range), and transmitting 314 the sponsorship request to a different department if the received budget information is above the second threshold budget (i.e., above the pre-determined budge range). If either of these situations is true, the method then ends.

If instead, the threshold analyzer 106 determines that the received budget information is above the first threshold budget and also below the second threshold budget, the method 300 requests 316 that the user 108 create a user account and transmits 318 potential schedules to air a message from the user from the scheduler 112. The method 300 then receives 320 a chosen schedule from the user 108, transmits 322 potential airtimes to air the message, receives 324 a chosen airtime from the user 108, queries 326 the user 108 for the goal of the sponsorship, and receives 328 the goal of the sponsorship from the user 108. The method 300 then transmits a creative/copy generation form to the user 108 from the AD copy generator 114, receives 330 from the user 108 the completed creative/copy generation form 128, queries the user 108 for payment information, and receives 332 payment information from the user with the payment system 110.

The method 300 then sends the user 108 information regarding the terms and conditions of service and the receives 334 the acknowledgement from the user 108 of the terms and condition. In response, the method 300 then generates 336 a preapproved message 116 from the completed creative/copy generation form 128 with the advertisement copywriting generator 114 and transmits the preapproved message 116 to the user 108 for approval.

The method 300 then determines 338 if the user 108 approves of the preapproved message 116. If the user 108 does not approve the preapproved message 116, the user 108 may edit 340 the drat message and send back the system 100. The method 300 then generates and transmits 336 a new preapproved draft message 116 that is again sent to the user 108 for approval.

If the user 108 approves the preapproved draft message 116, the method 300 then charges 342 the user’s payment information and transmits 344 the approved message to a station traffic system 126 to air the approved message. The method 300 then ends.

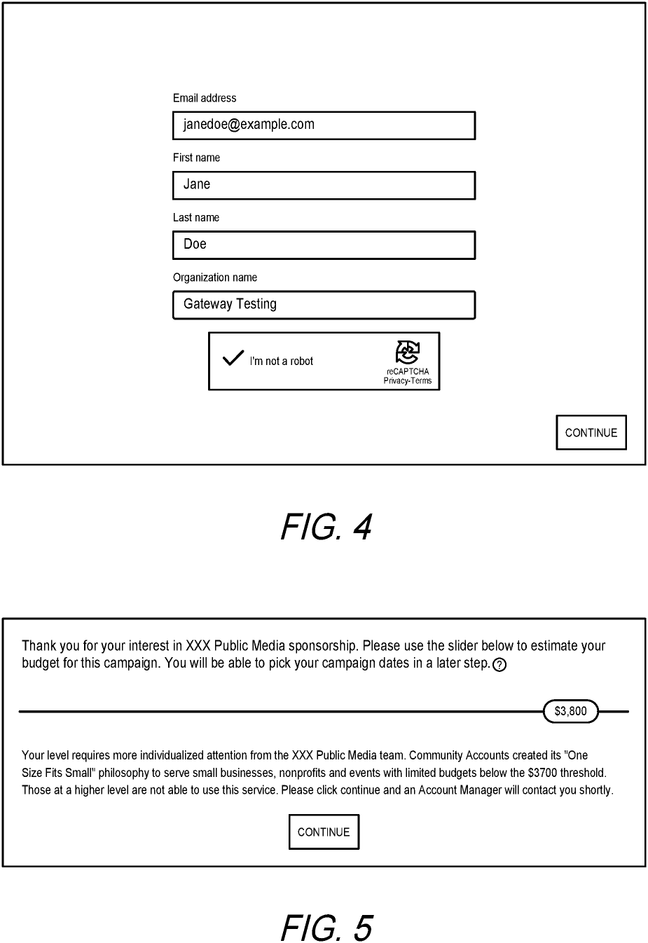

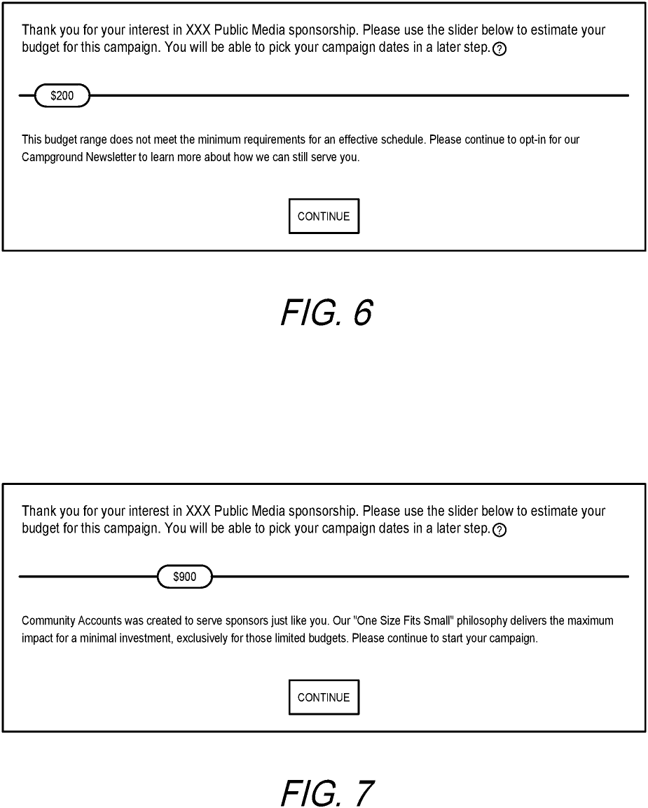

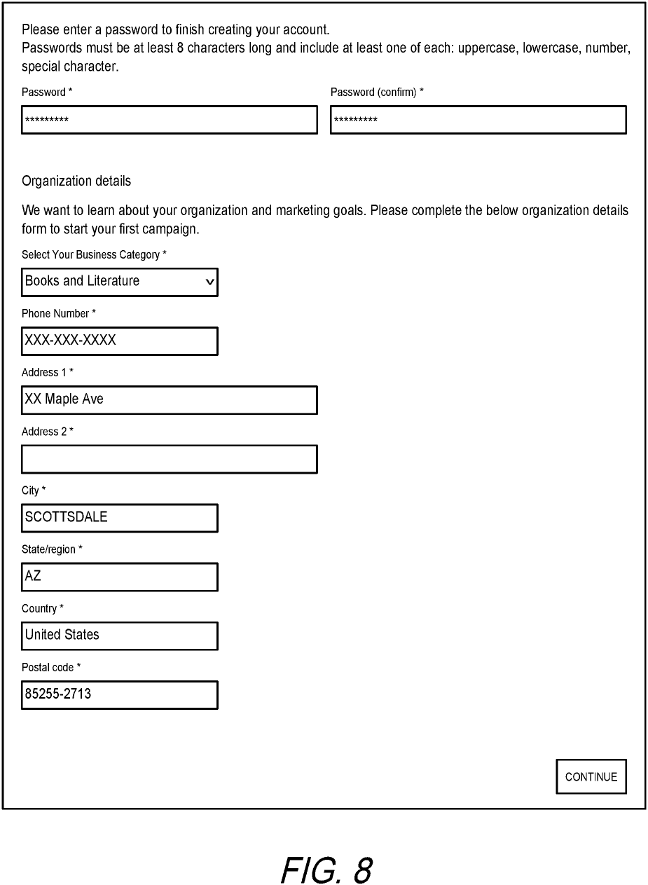

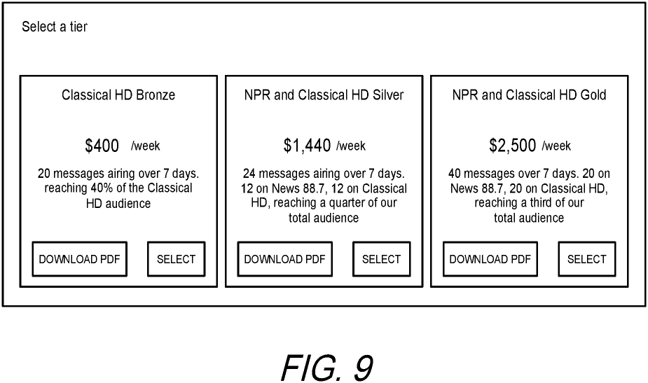

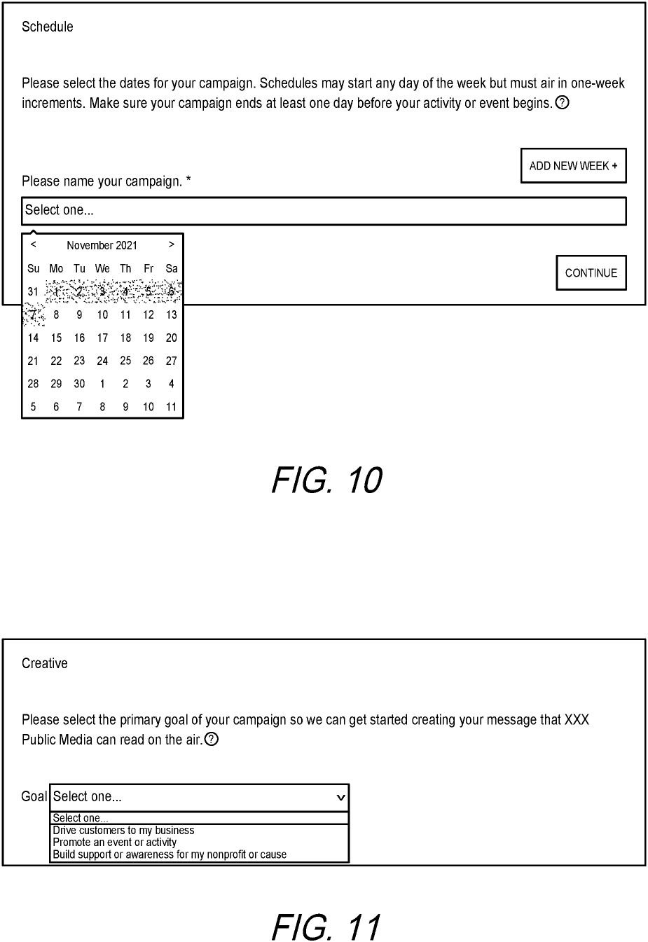

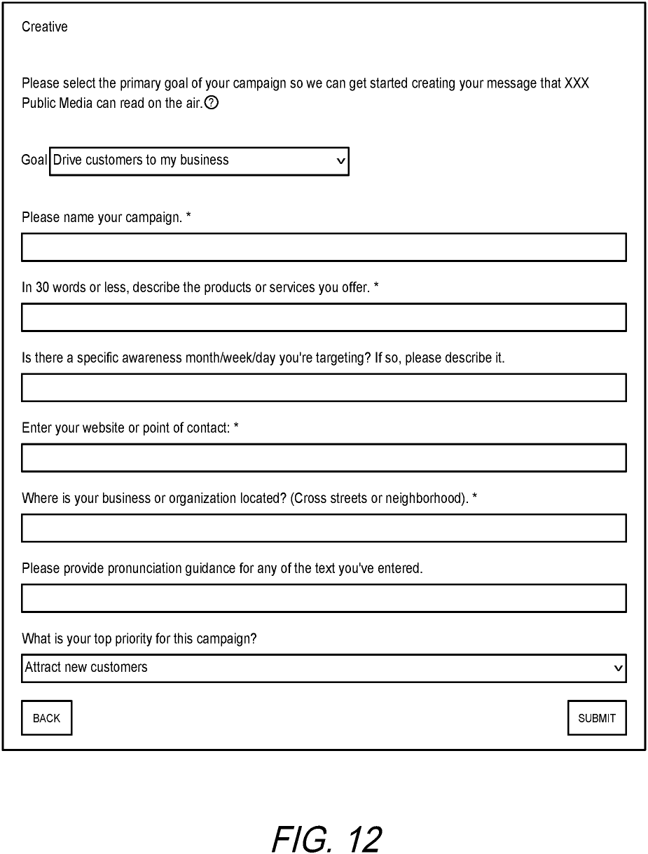

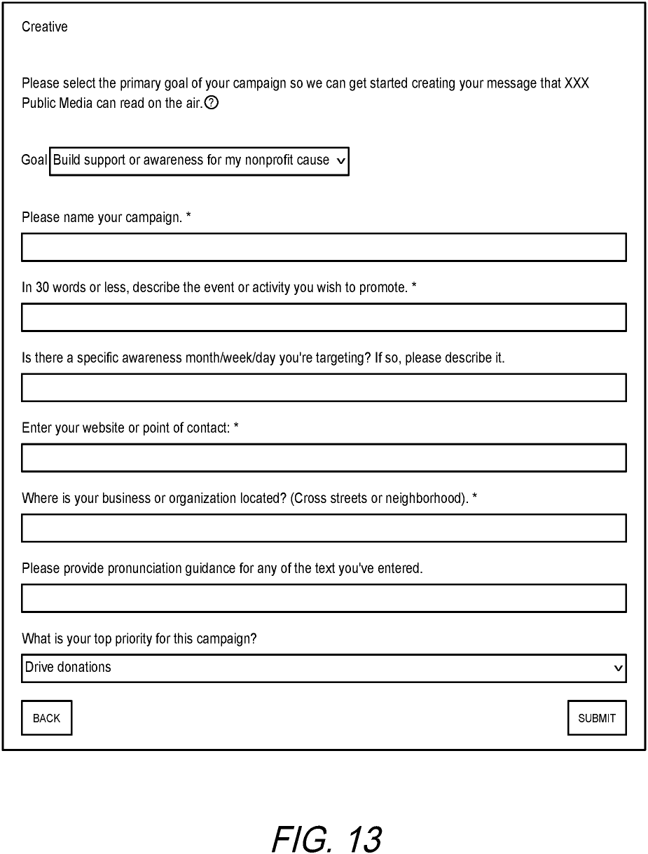

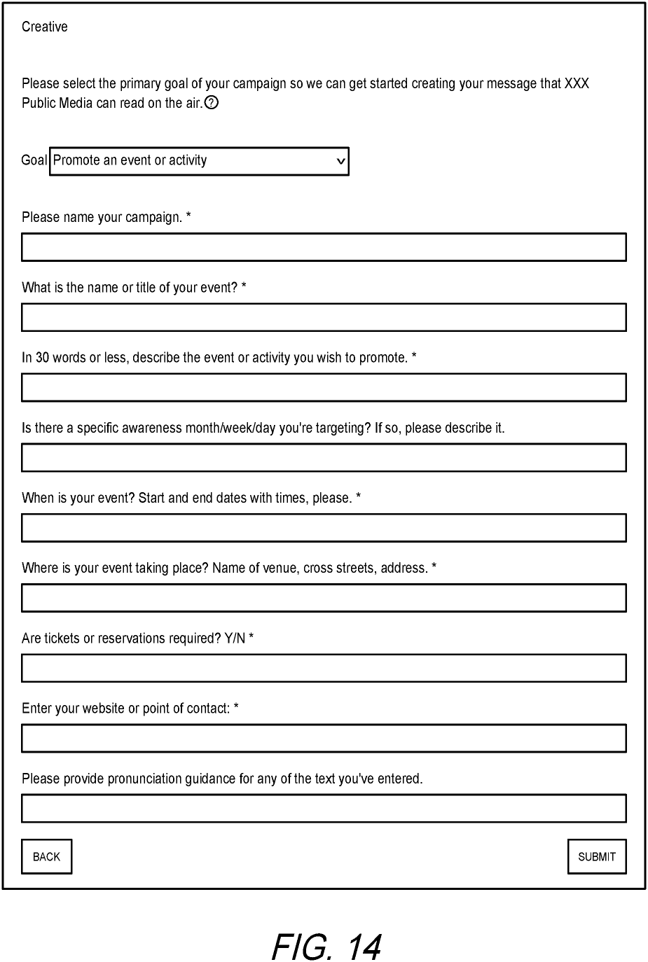

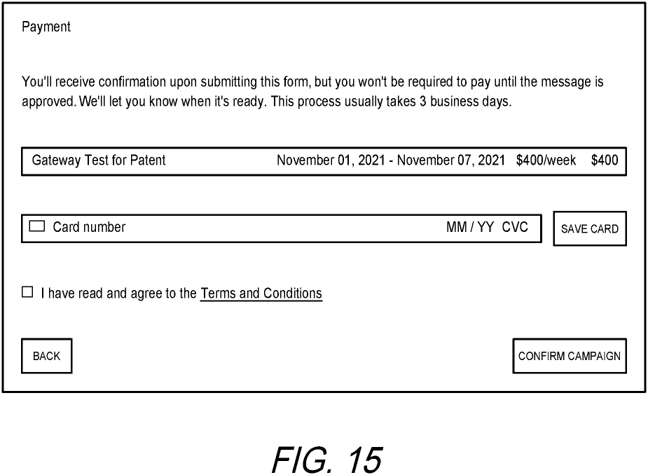

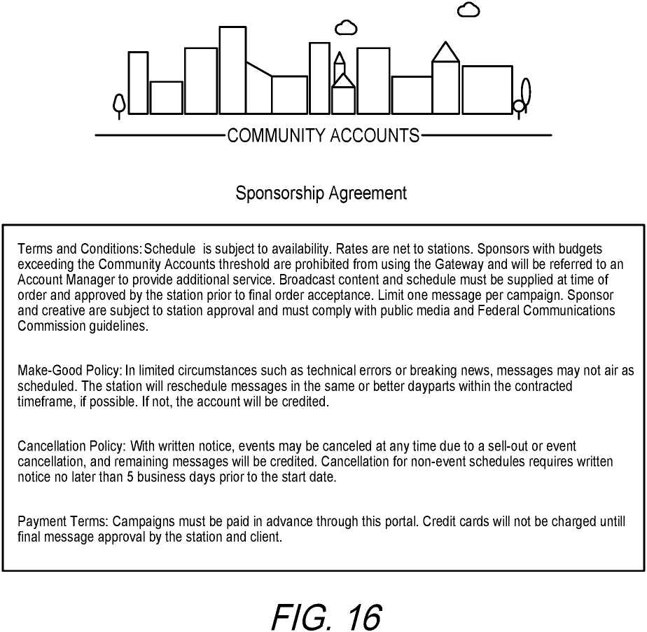

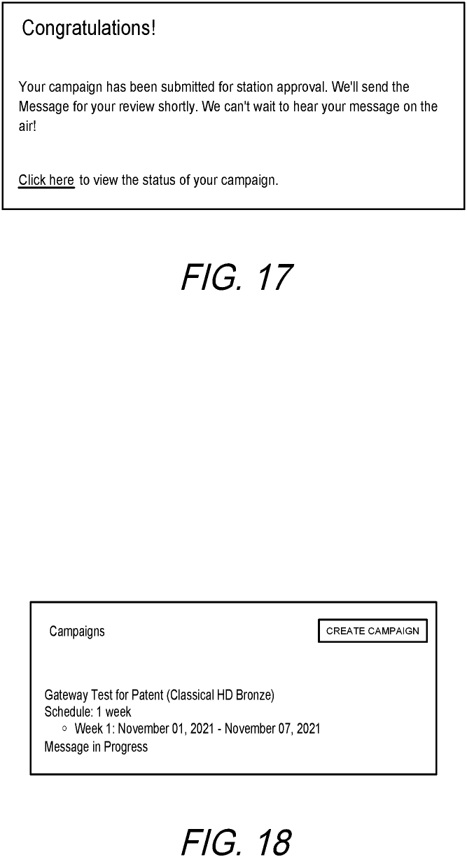

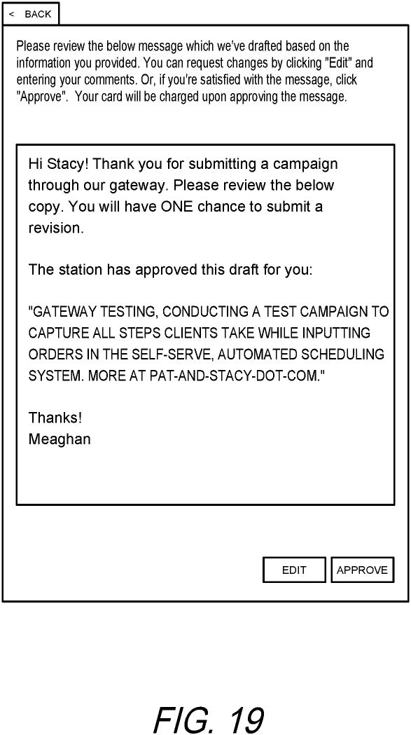

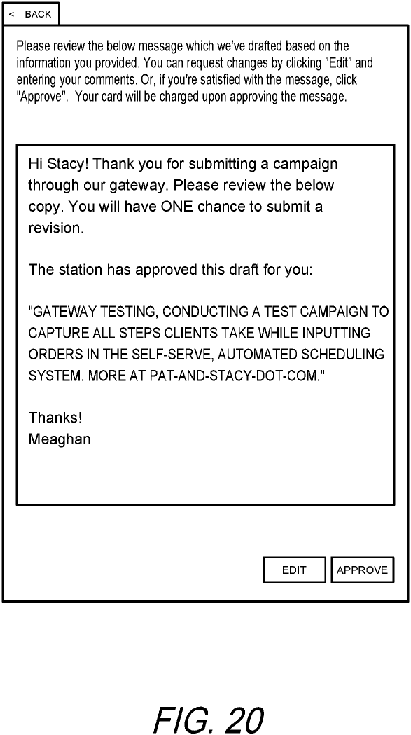

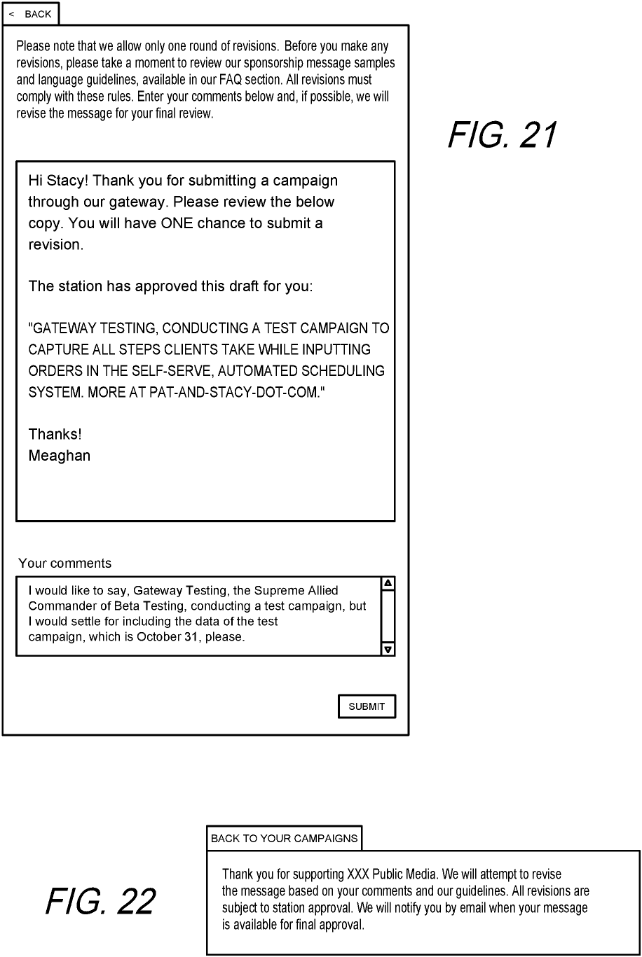

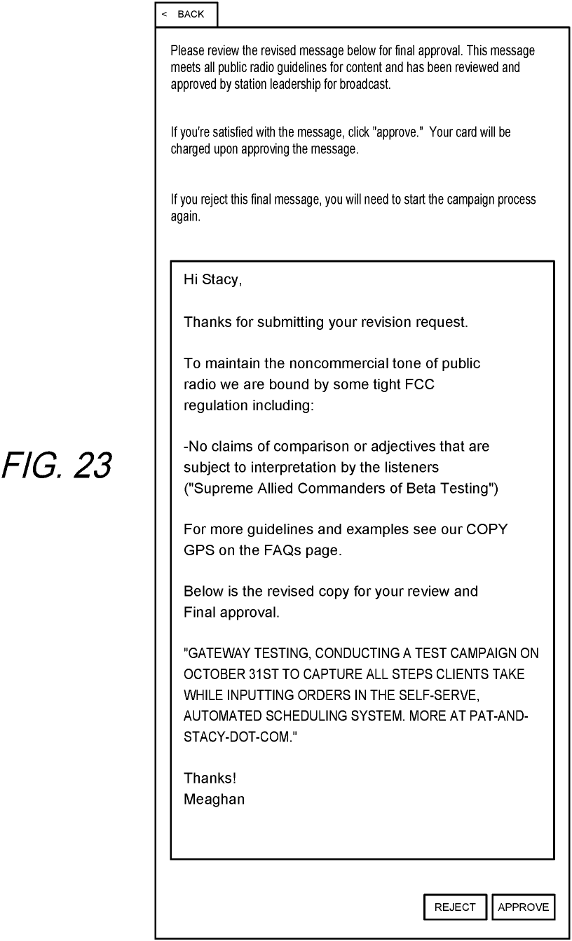

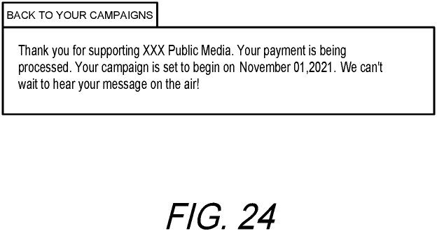

FIGS. 4 through 22 are example screen shots of communication between the system and a user on the user’s remote computing device.

Implementation examples are provided in the following numbered clauses.

1. A system for self-service public radio sponsorship ordering and copywriting of advertisement, the system comprising: a server including a threshold analyzer configured to receive a budget request from a user and determine if the budget request is within a pre-determined budget range, a payment system for receiving payment information from the user, a scheduler for scheduling an airtime for an advertisement from the user, and an advertisement copywriting generator for generating a preapproved draft message for the user, wherein the draft message is for the advertisement from the user; and a network interface in signal communication with the server, wherein the network interface is configured to communicate with a remote computing device over a telecommunication network.

2. The system of claim 1, wherein the advertisement copywriting generator is a system that utilize artificial intelligence to generate the preapproved draft message.

3. A system for self-service public radio sponsorship ordering and copywriting of advertisement, the system comprising: a communications interface; a computer-readable medium having executable instructions; a processor, in signal communication with the communications interface and the computer-readable medium, the processor configured to perform operations based on the executable instructions that include: receive from a user, utilizing a remote computing device, a sponsorship request via a telecommunication network; determine if the user has a budget that is within a pre-determined budget range, determine an airtime to air a message from the user; determine a goal of a sponsorship of the user; process a payment from the user; and generate a message to transmit over the air with a station traffic system.

4. The system for self-service public radio sponsorship ordering and copywriting of advertisement of claim 3, wherein determining if the budget of the user is within the pre-determined budget range includes requesting a budget from the user with the server, receiving the budget from the user at the server, and determining with a threshold analyzer if the received budget is within a pre-determined budget range.

5. The system for self-service public radio sponsorship ordering and copywriting of advertisement of claim 4, wherein determining if the received budget is within the pre-determined budget range includes determining with the threshold analyzer if the received budget information is below a first threshold budget or above a second threshold budget, and rejecting the sponsorship request if the received budget information is below the first threshold budget.

6. The system for self-service public radio sponsorship ordering and copywriting of advertisement of claim 4, further including transmitting the sponsorship request to a different department if the received budget is above the pre-determined budget range, wherein the received budget is above the pre-determined budget range if the received budget information is above the second threshold budget

7. The system for self-service public radio sponsorship ordering and copywriting of advertisement of claim 4, further requesting that the user create a user account if the received budget is within the pre-determined budget range.

8. The system for self-service public radio sponsorship ordering and copywriting of advertisement of claim 3, wherein determining the airtime to air the message from the user include transmitting potential schedules to air a message from the user from a scheduler, receiving a chosen schedule from the user, transmitting potential airtimes to air the message, and receiving a chosen airtime from the user

9. The system for self-service public radio sponsorship ordering and copywriting of advertisement of claim 3, wherein determining the goal of the sponsorship of the user includes querying the user for the goal of the sponsorship with the server, and receiving the goal of the sponsorship from the user.

10. The system for self-service public radio sponsorship ordering and copywriting of advertisement of claim 9, further including transmitting a creative/copy generation form to the user from an advertisement copywriting generator, and receiving from the user a completed creative/copy generation form.

11. The system for self-service public radio sponsorship ordering and copywriting of advertisement of claim 10, wherein processing the payment from the user includes querying the user for payment information with the server, and receiving payment information from the user.

12. The system for self-service public radio sponsorship ordering and copywriting of advertisement of claim 10, wherein generating the message to transmit over the air includes generating a preapproved message with the advertisement copywriting generator from the completed creative/copy generation form received from the user, transmitting the preapproved message to the user for approval.

13. The system for self-service public radio sponsorship ordering and copywriting of advertisement of claim 12, further including charging the payment information from the user if the user approves the preapproved message.

14. The system for self-service public radio sponsorship ordering and copywriting of advertisement of claim 3, further including transmitting the approved message to the station traffic system to air the approved message

15. A system for self-service public radio sponsorship ordering and copywriting of advertisement, the system comprising: means for receiving from a user, utilizing a remote computing device, a sponsorship request at a server remote from the remote computing device via a telecommunication network; means for determining if the user has a budget that is within a pre-determined budget range; means for determining an airtime to air a message from the user; means for determining a goal of a sponsorship of the user; means for processing a payment from the user; and means for generating a message to transmit over the air with a station traffic system.

16. A method for self-service public radio sponsorship ordering and copywriting of advertisement, the method comprising: receiving from a user, utilizing a remote computing device, a sponsorship request at a server remote from the remote computing device via a telecommunication network; determining if the user has a budget that is within a pre-determined budget range; determining an airtime to air a message from the user; determining a goal of a sponsorship of the user; processing a payment from the user; and generating a message to transmit over the air with a station traffic system.

17. The method of claim 16, wherein determining if the budget of the user is within the pre-determined budget range includes requesting a budget from the user with the server, receiving the budget from the user at the server, and determining with a threshold analyzer if the received budget is within a pre-determined budget range.

18. The method of claim 17, wherein determining if the received budget is within the pre-determined budget range includes determining with the threshold analyzer if the received budget information is below a first threshold budget or above a second threshold budget, and rejecting the sponsorship request if the received budget information is below the first threshold budget

19. The method of claim 18, further including transmitting the sponsorship request to a different department if the received budget is above the pre-determined budget range, wherein the received budget is above the pre-determined budget range if the received budget information is above the second threshold budget.

20. The method of claim 19, further requesting that the user create a user account if the received budget is within the pre-determined budget range.

21. The method of claim 16, wherein determining the airtime to air the message from the user includes transmitting potential schedules to air a message from the user from a scheduler, receiving a chosen schedule from the user, transmitting potential airtimes to air the message, and receiving a chosen airtime from the user.

22. The method of claim 16, wherein determining the goal of the sponsorship of the user includes querying the user for the goal of the sponsorship with the server, and receiving the goal of the sponsorship from the user

23. The method of claim 22, further including transmitting a creative/copy generation form to the user from an advertisement copywriting generator, and receiving from the user a completed creative/copy generation form.

24. The method of claim 23, wherein processing the payment from the user includes querying the user for payment information with the server, and receiving payment information from the user.

25. The method of claim 23, wherein generating the message to transmit over the air includes generating a preapproved message with the advertisement copywriting generator from the completed creative/copy generation form received from the user, transmitting the preapproved message to the user for approval.

26. The method of claim 25, further including charging the payment information from the user if the user approves the preapproved message.

27. The method of claim 16, further including transmitting the approved message to the station traffic system to air the approved message.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as an example implementations of such techniques.

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, an indication that a device is configured to perform a stated function means that the device contains appropriate equipment (e.g., circuitry, mechanical device(s), hardware, software (e.g., processor-readable instructions), firmware, etc.) to perform the stated function. That is, the device contains equipment that is capable of performing the stated function, e.g., with the device itself having been designed and made to perform the function, or having been manufactured such that the device includes equipment that was designed and made to perform the function. An indication that processor-readable instructions are configured to cause a processor to perform functions means that the processor-readable instructions contain instructions that when executed by a processor (after compiling as appropriate) will result in the functions being performed.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, a wireless communication device may communicate through one or more wired connections as well as through one or more wireless connections.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium,” “processor-readable medium,” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Furthermore, the description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention.

The claims and their equivalents define the scope of the invention.

Components, functional or otherwise, shown in the figures and/or discussed herein as being connected or communicating with each other are communicatively coupled. That is, they may be directly or indirectly connected to enable communication between them.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

What is claimed is:

1. A system for self-service public radio sponsorship ordering and copywriting of advertisement, the system comprising:
a server including
a threshold analyzer configured to receive a budget request from a user and determine if the budget request is within a pre-determined budget range,
a payment system for receiving payment information from the user,
a scheduler for scheduling an airtime for an advertisement from the user, and
an advertisement copy writing generator for generating a preapproved draft message for the user, wherein the draft message is for the advertisement from the user; and
a network interface in signal communication with the server, wherein the network interface is configured to communicate with a remote computing device over a telecommunication network.

2. The system of claim 1, wherein the advertisement copywriting generator is a system that utilize artificial intelligence to generate the preapproved draft message.

3. A system for self-service public radio sponsorship ordering and copywriting of advertisement, the system comprising:
a communications interface;
a computer-readable medium having executable instructions; and
a processor, in signal communication with the communications interface and the computer-readable medium, the processor configured to perform operations based on the executable instructions that include:
receive from a user, utilizing a remote computing device, a sponsorship request via a telecommunication network;
determine if the user has a budget that is within a pre-determined budget range;
determine an airtime to air a message from the user;
determine a goal of a sponsorship of the user,
process a payment from the user; and
generate a message to transmit over the air with a station traffic system.

4. The system for self-service public radio sponsorship ordering and copywriting of advertisement of claim 3, wherein determining if the budget of the user is within the pre-determined budget range includes
requesting a budget from the user with the server,
receiving the budget from the user at the server, and
determining with a threshold analyzer if the received budget is within a pre-determined budget range.

5. The system for self-service public radio sponsorship ordering and copywriting of advertisement of claim 4, wherein determining if the received budget is within the pre-determined budget range includes
determining with the threshold analyzer if the received budget information is below a first threshold budget or above a second threshold budget, and
rejecting the sponsorship request if the received budget information is below the first threshold budget.

6. The system for self-service public radio sponsorship ordering and copywriting of advertisement of claim 4, further including transmitting the sponsorship request to a different department if the received budget is above the pre-determined budget range, wherein the received budget is above the pre-determined budget range if the received budget information is above the second threshold budget.

7. The system for self-service public radio sponsorship ordering and copywriting of advertisement of claim 4, further requesting that the user create a user account if the received budget is within the pre-determined budget range.

8. The system for self-service public radio sponsorship ordering and copywriting of advertisement of claim 3, wherein determining the airtime to air the message from the user includes
transmitting potential schedules to air a message from the user from a scheduler,
receiving a chosen schedule from the user,
transmitting potential airtimes to air the message, and
receiving a chosen airtime from the user.

9. The system for self-service public radio sponsorship ordering and copywriting of advertisement of claim 3, wherein determining the goal of the sponsorship of the user includes
querying the user for the goal of the sponsorship with the server, and
receiving the goal of the sponsorship from the user.

10. The system for self-service public radio sponsorship ordering and copywriting of advertisement of claim 9, further including
transmitting a creative/copy generation form to the user from an advertisement copywriting generator, and
receiving from the user a completed creative/copy generation form.

11. The system for self-service public radio sponsorship ordering and copywriting of advertisement of claim 10, wherein processing the payment from the user includes
querying the user for payment information with the server, and
receiving payment information from the user.

12. The system for self-service public radio sponsorship ordering and copywriting of advertisement of claim 10, wherein generating the message to transmit over the air includes
generating a preapproved message with the advertisement copywriting generator from the completed creative/copy generation form received from the user,
transmitting the preapproved message to the user for approval.

13. The system for self-service public radio sponsorship ordering and copywriting of advertisement of claim 12, further including charging the payment information from the user if the user approves the preapproved message.

14. The system for self-service public radio sponsorship ordering and copywriting of advertisement of claim 3, further including transmitting the approved message to the station traffic system to air the approved message.

15. A system for self-service public radio sponsorship ordering and copywriting of advertisement, the system comprising:
means for receiving from a user, utilizing a remote computing device, a sponsorship request at a server remote from the remote computing device via a telecommunication network;
means for determining if the user has a budget that is within a pre-determined budget range;
means for determining an airtime to air a message from the user;
means for determining a goal of a sponsorship of the user,
means for processing a payment from the user, and
means for generating a message to transmit over the air with a station traffic system.

16. A method for self-service public radio sponsorship ordering and copywriting of advertisement, the method comprising:
receiving from a user, utilizing a remote computing device, a sponsorship request at a server remote from the remote computing device via a telecommunication network;
determining if the user has a budget that is within a pre-determined budget range;
determining an airtime to air a message from the user,
determining a goal of a sponsorship of the user;
processing a payment from the user; and
generating a message to transmit over the air with a station traffic system.

17. The method of claim 16, wherein determining if the budget of the user is within the pre-determined budget range includes
requesting a budget from the user with the server,
receiving the budget from the user at the server, and
determining with a threshold analyzer if the received budget is within a pre-determined budget range.

18. The method of claim 17, wherein determining if the received budget is within the pre-determined budget range includes
determining with the threshold analyzer if the received budget information is below a first threshold budget or above a second threshold budget, and
rejecting the sponsorship request if the received budget information is below the first threshold budget.

19. The method of claim 18, further including transmitting the sponsorship request to a different department if the received budget is above the pre-determined budget range, wherein the received budget is above the pre-determined budget range if the received budget information is above the second threshold budget.

20. The method of claim 19, further requesting that the user create a user account if the received budget is within the pre-determined budget range.

21. The method of claim 16, wherein determining the airtime to air the message from the user includes
transmitting potential schedules to air a message from the user from a scheduler,
receiving a chosen schedule from the user,
transmitting potential airtimes to air the message, and
receiving a chosen airtime from the user.

22. The method of claim 16, wherein determining the goal of the sponsorship of the user includes
querying the user for the goal of the sponsorship with the server, and
receiving the goal of the sponsorship from the user.

23. The method of claim 22, further including
transmitting a creative/copy generation form to the user from an advertisement copywriting generator, and
receiving from the user a completed creative/copy generation form.

24. The method of claim 23, wherein processing the payment from the user includes
querying the user for payment information with the server, and
receiving payment information from the user.

25. The method of claim 23, wherein generating the message to transmit over the air includes
generating a preapproved message with the advertisement copywriting generator from the completed creative/copy generation form received from the user,
transmitting the preapproved message to the user for approval.

26. The method of claim 25, further including charging the payment information from the user if the user approves the preapproved message.

27. The method of claim 16, further including transmitting the approved message to the station traffic system to air the approved message.
